(19) United States
(12) Patent Application Publication
(10) Pub. No.: US 2002/0126689 A1
(43) Pub. Date: Sep. 12, 2002

(54) System and method for dynamic local loop bandwidth multiplexing

(75) Inventor: Stephen H. Redington, Wharton, NJ (US)

Correspondence Address: HAMILTON, BROOK, SMITH & REYNOLDS, P.C., 530 VIRGINIA ROAD, P.O. BOX 9133, CONCORD, MA, 01742-9133, US

(73) Assignee: Pivotech Systems, Inc., Piscataway, NJ

(21) Appl. No.: 10/025,208

(22) Filed: Dec. 19, 2001

Related U.S. Application Data
(60) Provisional application No. 60/259,244, filed on Dec. 29, 2000.

(51) Int. Cl. H04B 7/212; H04J 3/02

(52) U.S. Cl. 370/442; 370/537

(57) ABSTRACT

A system and method for dynamically multiplexing multiple streams of packet data within a digital transmission media such as a T-1, E-1 or digital subscriber line (DSL). The approach allows such multiplexed packet streams to co-exist with voice transmitted via conventional time division multiplex (TDM) techniques. The approach also uses TDM bandwidth for packet data transmission when TDM voice channels are not in use.

### RELATED APPLICATION

This application claims the benefit of U.S. Provisional Application No. 60/259,244, filed on Dec. 29, 2000. The entire teachings of the above application are incorporated herein by reference.

### BACKGROUND

Digital data transported across the access loop of a telephone network can be classified as one of two types. The first type, called time division multiplex (TDM), is well known for its method of subdividing the bandwidth of a transmission channel into several smaller bandwidth channels. A time interval is split into several smaller time intervals typically called channels or time slots. Each channel is allowed to transmit within its own unique time period in a predetermined sequence. Once all channels have been transmitted, the sequence is repeated. The method requires a mechanism for determining the start of the sequence at the receiver, also called the frame, such that the receiver can determine the point in time where a particular channel can be recovered. An illustration of such a framed transmission is presented in FIG. 1 wherein n channels (TS1, TS2, . . . TSn) are provided within a given frame interval 10.

Digital carriers utilized in the access loop of a telephone network typically employ a framed TDM transmission method. Some examples include T-1, E-1 and framed Digital Subscriber Line (DSL). The smallest unit of bandwidth accessible in the carrier is known as a DS0 in the Digital Signal Hierarchy. A DS0 is understood to be a 64-kilo bits per second (kbps) unit of bandwidth.

The TDM data stream may be used to transmit various forms of digital information. Conventional voice transmission uses TDM to transport digital voice samples. Typically, an additional TDM stream is present to indicate signaling state information of the associated TDM voice channel. Such signaling information is typically called channel associated signaling (CAS). Such signaling information may be carried in-band as a portion of the DS0 voice payload. T-1 transmission systems implement CAS signaling by periodically “robbing” the least significant bit of the DS0, hence the name Robbed Bit Signaling (RBS). In such a system, the framing pattern of the transmission system allows the receiver to correctly recover the robbed bits and reconstruct the original signaling information. The CAS signaling information may also be carried out-of-band within a designated DS0 channel. E-1 transmission systems implement CAS signaling by allocating the 16th TDM time slot for signaling transport. Like the T-1 system, the framing pattern of the E-1 allows the receiver to correctly recover the signaling information of each voice channel.

The second type of digital transmission can be identified when the transmission does not require a framed format or periodic time interval to divide transmission bandwidth. This method of transmission utilizes a set of rules, or protocol, to determine the start and end of a data transmission. The information transmitted in such an interval is better known as a packet. Several transmission protocols exist. Many are utilized for the serial transmission of data in the access network. Some common examples are Point to Point Protocol (PPP), High-level Data Link Control (HDLC) protocol, Frame Relay and Asynchronous Transfer Mode (ATM). A characteristic common to all packet data transmission is the absence of an established time interval to distinguish individual data packets. Another characteristic of packet data is that it is typically transmitted as a serial stream of bits, a bit being the smallest unit of digital data. For this reason, all such data is referred to herein as Bit Sequential Data (BSD) when transmitted across the access loop.

A problem arises when time critical packet voice, or similar data, must be transmitted over the local loop along with packet data traffic such as from a typical local area network (LAN). In such cases, the time critical data must be transmitted with guarantees to meet minimum delay and delay variation requirements (latency and jitter) while the packet data traffic must meet minimum throughput requirements. Currently, two transmission techniques are used to meet these different objectives. Asynchronous transfer mode (ATM) techniques solve the problem by breaking up the data into small but consistent packets, called cells, which can be easily recognized and switched. Each cell consists of 53 bytes, five of which contain information used to describe and switch the cell contents. ATM is currently used for transport over the local loop since it provides many features that enable transport of a wise range of payload types as well as managing bandwidth. Since the use of ATM is widespread in the network backbone, payloads transported over the local loop using ATM can integrate easily into the infrastructure of a service provider.

ATM is modified to suit the needs of a particular type of payload by the use of an ATM Adaptation Layer (AAL) of which five are currently defined, not including AAL0, which is the most basic ATM protocol data unit (PDU) common to all higher adaptation layers. The different adaptation layers tailor the ATM cell to meet transmission requirements of various types of data traffic. AAL2 and AAL5 are two such adaptation layers that are best suited to the local loop problem. For additional information related to the ATM adaptation layers, the reader is directed to ITU Recommendation 1.363 (03/93)-B-ISDN ATM adaptation layer (AAL) specification. However, a problem with ATM solutions is the decrease in transmission bandwidth efficiency when used to transport packets of data, such as from a LAN. The problem is most notable when the packet is small or does not completely fill the payload of a cell. Each ATM cell used to carry any portion of the original data packet adds five or more bytes of overhead. Cell padding is added in cases where the ATM payload cannot be completely filled. Such padding further reduces transmission efficiency.

Another technique also applied to local loop transport of packet data is the use of PPP or Frame Relay protocols. This approach maintains the data in its native packet format embodied within the transport protocol. Here, real-time critical packet data is interleaved with non-real-time packets. To be able to make guarantees on the time critical portion of the data, large data packets may be split into smaller packets. These packets must be small enough to insure the time critical packet never has to wait beyond a specified time interval. This technique, called fragmentation, increases the transmission bandwidth overhead of data packets that are greater than a specified maximum transmit unit (MTU). This happens because each fragment must carry additional information used to properly recombine the fragments back into their original packet. In either the ATM or PPP case, the problem of efficiently interleaving the time critical and non-time critical data must still be solved. Current solutions involving queuing algorithms or fragmentation algorithms at the transmitting end of the loop are complex and lower the overall bandwidth efficiency of the transport media.

Transport of data utilizing TDM techniques tends to be more efficient than packet techniques since no overhead need be added to distinguish one stream of data from another. As a result, transmission efficiencies can approach 100% for TDM streams whereas bit sequential data (BSD) streams may be as low as 50% efficient or typically no higher than 80% efficient in the overall transmission of data. A problem arises with conventional TDM transmission in that the TDM bandwidth must be permanently allocated to a data stream. The resulting problem is that the allocated bandwidth is wasted when the TDM channel is not used or no data is available to transmit. This is most prevalent in the transmission of voice data. In such cases, the transmission channel is not used for an overwhelming majority of time. The resulting bandwidth utilization efficiency of the transport media becomes extremely poor.

Known methods to improve bandwidth utilization do so by dynamically switching bandwidth between voice and data when voice is not in use. These include methods that switch bandwidth within a DS0 from a TDM data source to a data network transporting data traffic.

U.S. Pat. No. 6,009,106 issued to Rustad et al. discloses a method wherein idle TDM channels are allocated to an unswitched digital data path. This method achieves dynamic bandwidth multiplexing by redefining and utilizing a signaling bit embedded in the robbed bit signaling of a T-1 carrier. There are several limitations to this approach. One is that the full 64 kbps bandwidth of the DS0 cannot be assigned to carry unswitched data traffic since 8 kbps must be allocated to carry the signaling information for each DS0. This can amount to 192 kbps of wasted bandwidth in a T-1 carrier where all 24 DS0 channels are idle. A second limitation is that only one unswitched data source can be accommodated. This method would not be suitable in applications where some of the BSD traffic has real-time constraints. In addition, the approach of Rustad becomes cumbersome when implemented in carriers other than a T-1 since robbed bit signaling is inherently dependent on T-1 framing.

U.S. Pat. No. 5,467,344 issued to Solomon et al. discloses another dynamic bandwidth approach wherein channel assignment messages are used in addition to the use of special pad characters injected into a packet band. The requirement for the receipt of an acknowledgment message from the receive end of the loop makes the amount of pad code injected indeterminate. This problem arises because the number of frame delays end to end can vary and such acknowledge messages can become lost or corrupted in transmission. Delays associated with acknowledgment messages for any reason wastes bandwidth.

### SUMMARY

Known bandwidth allocation approaches fail to address real-time critical aspects that can be applicable to a portion of BSD traffic. These methods also tend to be complicated and do not make optimum use of the available bandwidth.

The present invention provides for increased bandwidth efficiency over existing solutions such as ATM or PPP while preserving real-time performance for critical applications in an approach that is independent of the underlying physical transport (e.g., T1, E1, DSL or other channelized carrier transports).

A dynamic loop bandwidth multiplexing (DLBM) system and method of the present approach improves bandwidth utilization when time critical packet voice, or similar data, is to be transmitted over a local loop along with packet data traffic such as from a typical local area network (LAN). A benefit of the DLBM system is the ability to maximize the bandwidth of local loop facilities under varying traffic types and load conditions. The present approach provides optimization of packet data traffic bandwidth, such as Internet Protocol (IP) traffic, in the local loop of an access network while ensuring the quality of service (QOS) for real-time data transmission. Another benefit of the system is the ability to transport toll quality voice and dynamically multiplex TDM voice bandwidth, thus recovering TDM bandwidth that would otherwise be consumed for idle periods.

The system provides simultaneous transmission paths for BSD traffic over the same local loop. One path adjusts bandwidth based upon input flow rates and is best suited for real-time critical data. Another path can be provisioned to meet minimum bandwidth requirements and utilizes additional bandwidth recovered from either idle TDM voice channels or unused real-time bandwidth. The system includes a control channel in the transport media to dynamically allocate the optimum bandwidth to each transmission path.

Accordingly, an apparatus of the present approach features an insertion circuit that combines first and second bit streams into a time division multiplexed (TDM) output bit stream that can be coupled to a transmission loop such as a DSL, T1 or E1 carrier. The first bit stream is a TDM input bit stream, the TDM input and output bit streams being divisible into frames, each frame including plural channels. The second bit stream is an unframed stream of bit sequential data (BSD). The insertion circuit is adapted to insert bits from the second bit stream into one or more channels of the first bit stream to provide the TDM output bit stream. The bits are inserted into at least one channel of the TDM input bit stream that is designated for carrying either TDM data or BSD depending on a usage state of the channel. A control interleaver interleaves control information with the BSD wherein the control information includes bandwidth allocation information between the TDM input and the BSD.

The apparatus further includes a multiplexer that multiplexes at least one primary BSD bit stream and at least one auxiliary BSD bit stream to provide the second bit stream, wherein the primary BSD bit stream comprises real time packet data and the auxiliary BSD bit stream comprises non-real time packet data. The multiplexer selects between the primary BSD bit stream and the auxiliary BSD bit stream based on a modulus value that indicates an allocation of available BSD bandwidth between the primary and auxiliary BSD bit streams. The modulus value can be adjusted based on an input rate associated with the primary BSD bit stream. In an embodiment, multiple BSD streams are accommodated by cascading dynamic bandwidth loop multiplexer systems of the present approach.

According to another aspect of the present approach, the auxiliary BSD bit stream includes interleaved control information which can be in the form of hardware control link protocol (HCLP) commands. The HCLP commands are inserted into a channel of the TDM input bit stream designated for carrying BSD and control information. The control information includes the modulus value and usage state information. The control information can be repeated to permit error detection and error correction at a far end device.

According to another aspect, apparatus at a far end receives a time division multiplexed (TDM) input stream divisible into frames, each frame having plural channels including channels designated for carrying either TDM data or bit sequential data (BSD) depending on usage state information of the channels. The far end apparatus includes an inverse multiplexer for separating data in the BSD channels into a primary BSD output bit stream and an auxiliary BSD output bit stream based on the usage state information and a modulus value that indicates an allocation of available BSD bandwidth between the primary and auxiliary BSD streams.

A control channel detector at the far end apparatus examines a control channel in the TDM input stream to determine the usage state information and modulus value.

The present approach improves the way in which bandwidth is controlled. ATM and IP transmission techniques ultimately add cell or packet overhead to control the loop bandwidth dynamically whereas the present system and method uses a control channel. The improvement is made because the added overhead of previous techniques consumes more bandwidth than the control mechanism used in the present approach.

### BRIEF DESCRIPTION OF THE DRAWINGS

The foregoing and other objects, features and advantages of the invention will be apparent from the following more particular description of preferred embodiments of the invention, as illustrated in the accompanying drawings in which like reference characters refer to the same parts throughout the different views. The drawings are not necessarily to scale, emphasis instead being placed upon illustrating the principles of the invention.

FIG. 1 is an illustration of conventional TDM transmission within a framed carrier.

FIG. 2 is a block diagram of a telecommunication system employing a dynamic loop bandwidth multiplexer system of the present approach.

FIG. 3 is a block diagram of Transmit End (TE) and Receive End (RE) elements of the dynamic loop bandwidth multiplexer system embodied in a unidirectional digital transmission loop with support for legacy T-1 voice channels utilizing robbed bit signaling.

FIG. 4 is a block diagram illustrating the TE and RE implemented as a full duplex transceiver between a telephone network and telephone subscriber.

FIG. 5 is a block diagram illustrating an embodiment of the TE element of the system.

FIG. 6 is a block diagram that illustrates a BSD insertion part of the TE element of FIG. 5.

FIGS. 7 and 8 illustrate examples of dynamic bandwidth allocation according to the present approach.

FIG. 9 is an illustration of HCLP injection within a designated control channel of the framed carrier.

FIG. 10 is an illustration of HCLP Op-Code format comprising command code and time sequence identifier elements.

FIG. 11 is an illustration of four HCLP commands that are transmitted in various frame intervals.

FIG. 12 is an illustration of HCLP command transmission and execution utilizing forward error correction with three redundant commands.

FIG. 13 is an illustration of CBI code transmission in a BSD stream aligned in the designated control channel.

FIG. 14 is an illustration of forced HCLP insertion that conflicts with a scheduled HCLP command insertion according to a first case.

FIG. 15 is an illustration of forced HCLP insertion that conflicts with a scheduled HCLP command insertion according to a second case.

FIG. 16 is a block diagram illustrating the implementation details of the Receive End (RE) element of the system.

FIG. 17 is a block diagram illustrating a cascaded configuration of dynamic loop bandwidth multiplexer systems of the present approach.

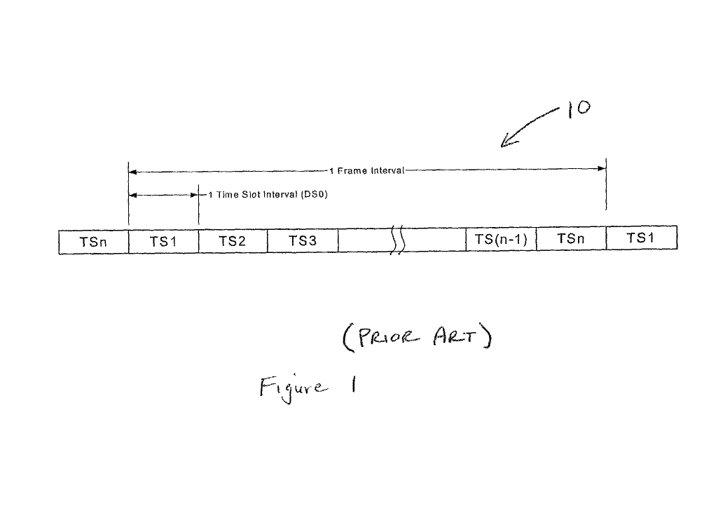

### DETAILED DESCRIPTION

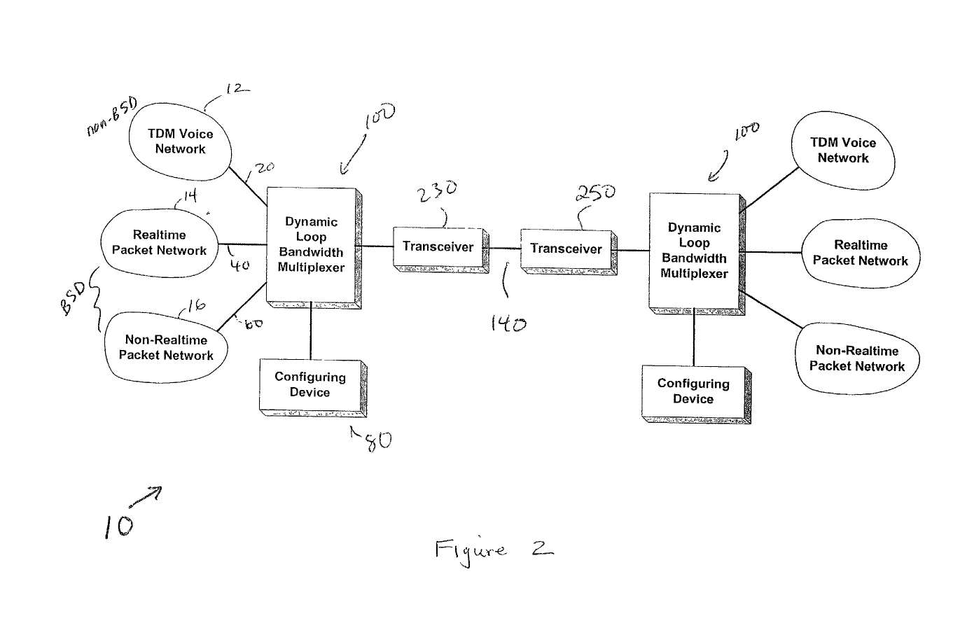

FIG. 2 illustrates an architecture 10 for the application of a dynamic loop bandwidth multiplexer (DLBM) 100 to transport an arbitrary combination of three data flows (20, 40, 60) across a transmission loop. The communication link 140 between the transceivers 230 and 250 represents a framed transmission media such as a T-1, E-1, DSL or other channelized carrier transport. The DLBM 100 transforms the data flows from each of three distinct data paths into a format suitable for the transmission media. A TDM voice network 12 transports TDM data 20 within fixed time slot allocations while the realtime and non-realtime packet networks 14, 16 transport data as serial bit streams 40, 60 respectively. The serial bit stream traffic does not rely on a framing time interval (as does TDM). This type of transmission is termed Bit Sequential Data (BSD). A configuring device 80 such as a microprocessor or other controller is used to provision the characteristics of the bandwidth multiplexing operation.

The following lists acronyms and abbreviations which are used throughout the specification. Note that throughout the specification, the terms “time slot” and “channel” are used interchangeably.

| | |
|---|---|
| ATM | Asynchronous Transfer Mode |
| BSD | Bit Sequential Data |
| CBI | Command Byte Introducer |
| CCE | Coincident CBI Event |
| COP | Continue Op-Code |
| DLC | Digital Loop Carrier |
| DS0 | Digital Signal Level 0 |
| DSL | Digital Subscriber Line |
| HCLP | Hardware Control Link Protocol |
| HDLC | High-level Data Link Control |
| IP | Internet Protocol |
| ITU | International Telecommunication Union |
| NOP | No Operation |
| PPP | Point to Point Protocol |
| QOS | Quality of Service |
| RBS | Robbed Bit Signaling |
| RE | Receive End |
| SFI | Signal Frame Interval |
| TCP | Transmission Control Protocol |
| TDM | Time Division Multiplex |
| TE | Transmit End |
| TSI | Time Sequence Indicator |
| UDP | User Datagram Protocol |

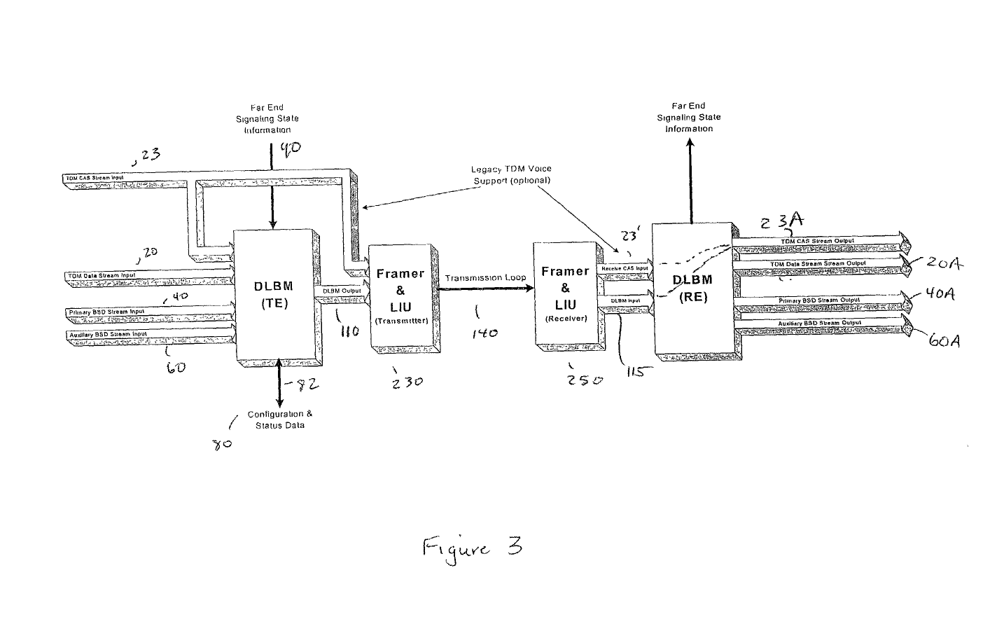

The diagram of FIG. 3 illustrates a unidirectional transmission path incorporating DLBM 100 with support for legacy signaling. Each unidirectional transmission path includes a transmit end (TE) and a receive end (RE). A framer and line interface unit (LIU) 230, 250 connect the TE and RE to the physical media used for transmission. The optional signaling support shown may be applicable when a T-1, E-1 or similar carrier is utilized as the underlying transport media. As shown, there are four streams of data that are input to the DLBM transmit end. The TDM data stream input 20 is used to transmit various forms of digital information. Conventional TDM voice transmission uses the TDM data stream input to transport digital voice samples. A TDM CAS input stream 23 may be present to indicate signaling state information of associated TDM voice channels. The packet data originating from the realtime and non-realtime data networks 14, 16 (FIG. 2) enter the DLBM transmit end as two independent BSD streams 40, 60 respectively. The realtime packet data is associated with the primary BSD stream input 40 while the non-realtime packet data is associated with the auxiliary BSD stream input 60. The configuring device 80 is used to control the operation and behavior of the DLBM transmit end.

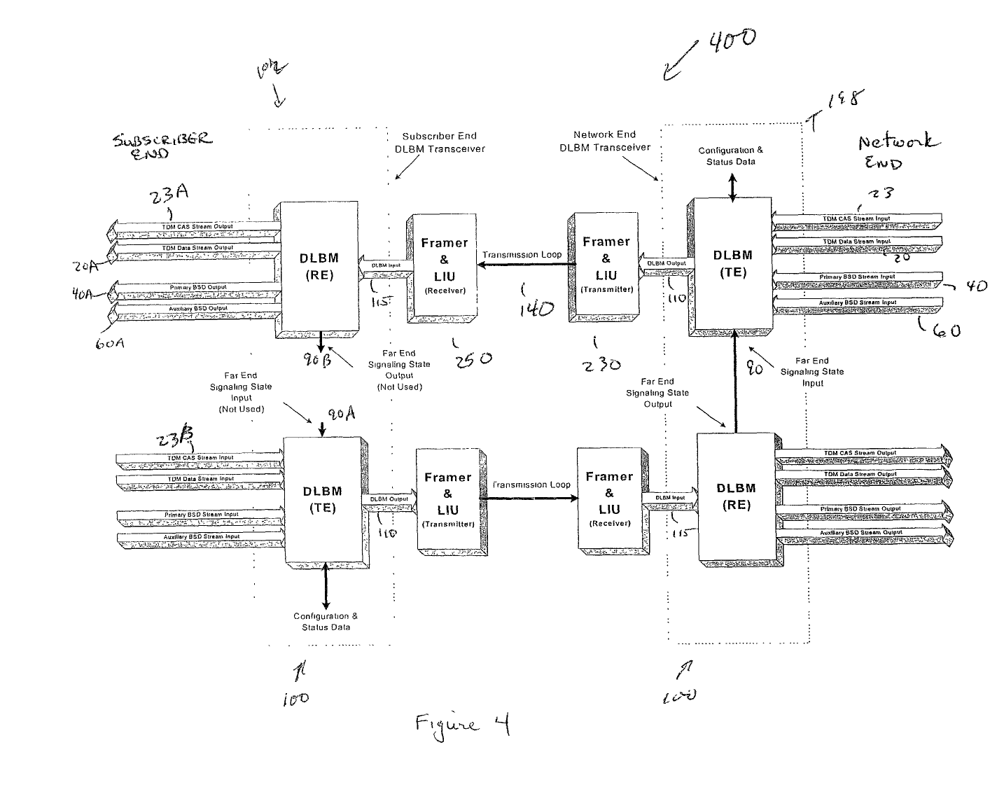

When present, the information within the TDM CAS stream input 23 is used by the DLBM transmit end in conjunction with far end signaling state information input 90 to determine the usage (i.e., active or idle) of a TDM data stream input channel. Note that the signaling state information 90 comprises signaling state information associated with the TDM CAS stream input 23B input at the subscriber end of a full duplex communication system as shown in FIG. 4. The DLBM receive end outputs TDM channel signaling state information 23A that is received from the far end of the loop. This is essentially the same information as the TDM CAS output stream. This output allows the TE access to signaling state information from the far end when a full duplex transmission path is established. Note that the signaling state information is not used in the embodiment shown in FIG. 3.

The far end signaling state information is optional to the DLBM. If TDM CAS signaling is not used, the far end signaling information is also not used. In the context of the DLBM, the far end is defined as the DLBM RE that is connected to the TE.

As shown in FIGS. 3 and 4, the DLBM transmit end combines the TDM and BSD streams into a DLBM output data stream 110. The DLBM output stream 110 is presented to framing and line interface unit (LW) 230 for transmission over the access loop. A corresponding framer and LIU 250 at the far end of the loop receives the data 110. The data is output from the framer as a DLBM data stream 115 and input to the DLBM receive end. The receive end reconstructs the original TDM and BSD streams 20A, 40A, 60A and outputs them.

The framer/LIU 230, 250 is a well-known device such as an integrated T1 framer/LIU (part number DS21352L) or integrated E1 framer/LIU (part number DS21354L) from Dallas Semiconductor. In applications in which the transport is provided over DSL, the framer/LIU can be, for example, a G.SHDSL transceiver (part number GS2237-108-001G-C1) from Globespan.

The TDM CAS signaling information is also reconstructed and output from the receive end at 23A. The same signaling information is output as the far end signaling information and made available to an adjacent DLBM transmit end, should there be one present. Two additional data paths shown in FIG. 3 are included as optional legacy support for channelized carriers such as a T-1 or E-1. As such, the framer and LIU combination may accept and output TDM CAS signaling directly. In the case of a T-1, the CAS signaling information is inserted into the associated TDM data channel overriding the least significant bit. This method of signaling is commonly referred to as robbed bit signaling (RBS) and uses information associated with the framing mechanism of the T-1 carrier to recover the signaling information. When used in conjunction with the DLBM system, the RBS capability of intermediate network elements is disabled for TDM data channels originating from and terminating at the DLBM equipment.

FIG. 3 shows TDM CAS input stream 23′ and DLBM input stream 115 connected on different paths through the DLBM (RE) to TDM CAS output stream 23A. In the case of legacy support (i.e., signaling transported via conventional RBS) the TDM CAS input stream 23′ is passed straight through the RE to TDM CAS Stream output stream 23A. The DLBM technology can also transport signaling as described herein. This latter signaling information can be converted to a conventional ABCD signaling output for the associated channels. The two streams of signaling are merged on a per channel basis and appear at TDM CAS output stream 23A.

There may be an occasion where a number of channels are to be sent to a destination where no DLBM RE exists. The DLBM cannot operate on such channels and they would be designated for TDM use only as described further herein. In such a case the legacy path shown in FIG. 3 is used in conjunction with the DLBM path. These channels can be stripped out by an intermediate network element and the remaining channels passed on to the DLBM RE. In the case where a T-1 carrier is used as the transport media, the RBS signaling insertion must be disabled for all channels that are not carrying TDM voice. This is necessary since the framer/LIU has no knowledge of the state of channels originating from the DLBM TE. Otherwise, if the framer/LIU were to insert RBS into such channels the data being transported would be corrupted.

The diagram of FIG. 4 illustrates the DLBM configured as a full duplex transceiver 400. In such cases, the TE and RE elements are co-located at each end 102, 198 of the transmission loop. The support for legacy CAS signaling has been omitted in the diagram of FIG. 4. This implies that the DLBM at both ends of the transmission loop is used to transport all signaling information associated with TDM voice channels. In this arrangement, the signaling transport becomes independent of the transport media and the DLBM output is transported as pure data. When the TE is located at the subscriber end 102 of a TDM voice transmission loop, the far end signaling state input 90A is not used and the far end signaling state output 90B from the RE may be left unconnected. In this case, the utilization of the voice channel toward the phone network may be determined solely by the state of the subscriber telephone (i.e., on-hook or off-hook). When the TE is located at the network end of a TDM voice transmission loop, the far end signaling information obtained from the RE is input directly into the TE as shown. This information is used in conjunction with the TDM CAS stream input to determine the corresponding TDM voice channel state in the direction toward the voice subscriber. This allows the TE to correctly determine the channel status for all signaling protocols.

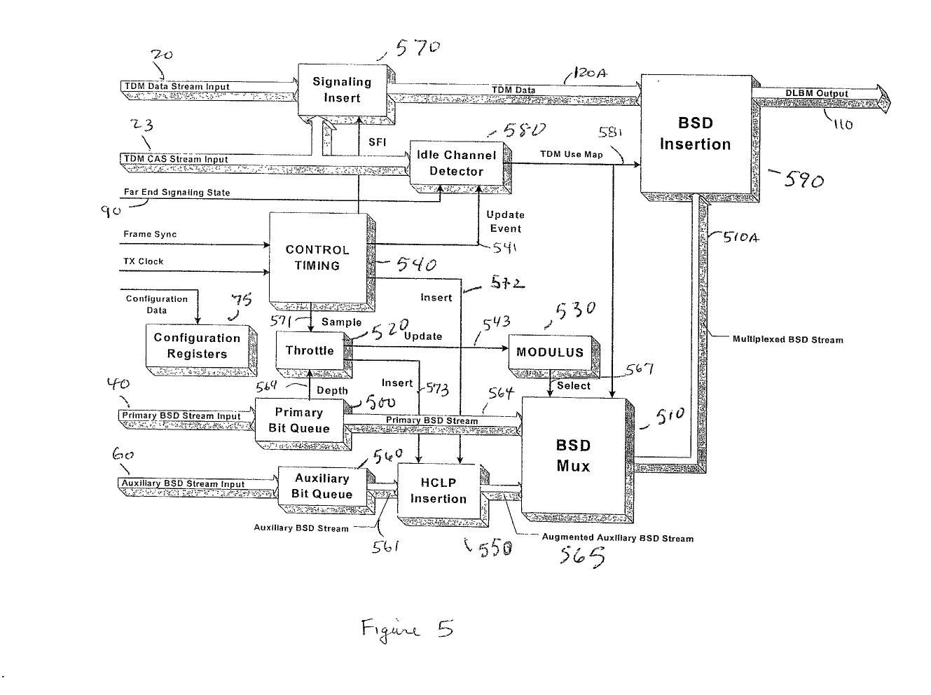

Operation of the DLBM transmit end as shown in FIG. 5 can be understood by describing the TDM data path first and then describing the BSD paths. Each channel of the TDM data stream input that passes through the DLBM is assigned a designation. The appropriate DLBM configuration register 75 is manipulated by the configuration device to determine its designation. There are four possible designations for each TDM input channel: 1) TDM Allocated, 2) Multiplex Eligible, 3) BSD Allocated, or 4) Not Used. TDM data stream input channels that are designated as TDM Allocated or Not Used are output from the DLBM transmit end without alteration. TDM data stream input channels that are designated BSD Allocated contain data inserted from a BSD stream when output from the TE. TDM data stream input channels that are designated Multiplex Eligible contain BSD data when the TE determines that the channel is not being used to transport voice or TDM data. Otherwise, the channel contains TDM data.

In a typical application, the TDM Allocated channel is used to carry TDM data. For example, the TDM data may be associated with Digital Data Service (DDS) 64 kbps clear data channel service or some other provisioned data service.

The TDM data stream input enters the DLBM transmit end and is first acted upon by a Signaling Insert module 570 in cases where a TDM CAS Stream input is provided and in-band signaling transport is desired. A Control Timing module 540 block establishes a Signal Frame Interval (SFI) 542 used to time the insertion of HCLP commands via HCLP insertion block 550. The SFI time interval is based on the frame sync timing information input to the DLBM transmit end. In an embodiment, the SFI time interval comprises twenty-four frame sync time intervals of uniform length. The data within TDM channels designated Multiplex Eligible are altered every six frame intervals, starting with the frame that corresponds to an SFI time interval. The CAS data associated with each TDM voice channel consists of four data bits designated the ‘ABCD’ signaling bits. The first frame coincident with the SFI time interval is counted as frame one. After six frame intervals are counted, the ‘A’ bit is inserted into the least significant bit position of the corresponding TDM channel. The ‘B’ bit is inserted in a similar fashion twelve frames after the SFI time interval. Similarly, the ‘C’ and ‘D’ bits are inserted in the eighteenth and twenty-fourth frames. The sequence then repeats at the start of the next SFI time interval.

The described sequence of signaling bit insertion is the same method as robbed bit signaling used in T-1 carriers with the exception that the present approach is to rob bits in frame intervals counted with respect to an established SFI interval. The SFI time interval is different from an Extended Super Frame (ESF) used with T-1 carrier. The ESF boundary of a T-1 is established using a framing bit. In contrast, the SFI time interval of the present approach is established by means of an HCLP signal embedded in the designated control channel.

All operations for inserting signaling information into the TDM data stream input signal 20 are performed on a bit by bit basis. Individual bit positions and channel associations are determined by combinations of the transmit clock and frame sync inputs to the Control Timing block 540. This information is used by the Signaling Insert block 570 to locate the specific TDM channel and bit to be acted upon in the output 120A of the signaling insert block 570. Note that TDM channels that are designated as TDM Allocated, Not Used or BSD Allocated are not altered.

An Idle Channel Detector 580 receives TDM CAS stream input 23 and far end signaling state input information 90. Timing information received from the Control Timing block 540 allows the Idle Channel Detector 580 to determine the use state of the TDM data stream input channels designated as Multiplex Eligible. When TDM CAS Signaling is absent or unused an alternate means of determining the channel is provided by the configuring device 80 (FIG. 2). In this case an external entity determines the channel state (active or idle) and directly manipulates the use state information contained in the Idle Channel Detector 580.

A TDM Use Map signal 581 provides information as to whether each channel is idle or active with respect to TDM voice transport. The idle state corresponds to an on-hook condition at the subscriber while the active state corresponds to an off-hook. The TDM Use Map signal uses one binary bit to represent the state of each channel in the frame. For example, a ‘1’ bit can represent the active state while a ‘0’ bit can represent the idle state. Thus, for a T-1 frame, the use map is 24 bits while for an E-1 frame the use map is 32 bits. The bit state only has meaning for channels designated as Multiplex Eligible.

When the Idle Channel Detector block 580 receives an update event signal 541, a new TDM Use Map signal is output to BSD Insert module 590 and BSD Multiplexer module 510. The Control Timing module 540 coordinates the update event signal to the Idle Channel Detector module 580 such that the update is issued following the SFI time interval after a command referred to as a Hardware Control Link Protocol (HCLP) synchronize command has been inserted into the auxiliary BSD stream. Since all HCLP op-codes contained in the HCLP commands are issued at the start of an SFI boundary, the RE can predetermine the correct point in time to implement the corresponding change to its TDM use map. A register setting in the DLBM configuration register block 75 determines the frequency of update events. A typical update rate is about 10 times per second. If the update rate is too slow, then idle bandwidth in the TDM stream can be wasted. The configuring device 80 (FIG. 2) manipulates the appropriate DLBM configuration register to select a uniform time interval that is an integer multiple of the SFI time interval. The minimum time interval must be larger than the SFI time interval.

In an alternate embodiment, the Idle Channel Detector 580 can be bypassed or eliminated by employing an embedded processor (e.g., configuration device 80—FIG. 2) to provide the TDM Use Map directly without the need to determine use states from the CAS stream.

FIG. 6 further illustrates the Control Timing block 540, Idle Channel Detector block 580 and Configuration Registers block 75 used to generate the TDM use map signal 581 shown in FIG. 5. The Control Timing block 540 determines the time slot association (DS0 byte boundary) of a particular stream bit based on transmit clock and frame sync inputs that are supplied to a counter 540B the output of which is divided by 8 in divider 540A. This timing information is made available to those blocks 510, 590 that need to manipulate bit streams. This timing relationship is not explicitly shown in FIG. 5 but is detailed in FIG. 6 to indicate operation of module 590. The logic of the BSD Insertion block 590 can be a simple multiplexer 590A with a single control input. Input TDM CAS signaling information 23 (FIG. 5) is conditioned with the signaling information obtained from the far end 90 (FIG. 5) according to signaling protocol rules applicable to the particular voice network in use to derive the use state of each channel 580B (FIG. 6). As shown in FIG. 6, the use state information is conditioned with the associated channel designation information 75A. The TDM Use Map signal 581 is generated such that the TDM Data stream is always selected unless the channel is designated as BSD Allocated or designated as Multiplex Eligible and in the idle state. Thus the TDM use Map Signal is reduced to a simple binary state.

Upon receiving a TDM use map signal, the BSD Insert block 590 begins inserting BSD stream bits into designated TDM time slot channels on a DS0 byte boundary within the input TDM data stream 120A. TDM time slots designated BSD Allocated are filled with bit data obtained from the BSD stream. TDM time slots designated Multiplex Eligible are filled with bit data from one of two possible sources depending upon the indication in the corresponding TDM Use Map. If the TDM Use Map indicates that the TDM channel is not in use, the corresponding time slot is overwritten with bit data obtained from the BSD stream. If the use map indicates the channel is in use, the data in the input TDM stream is allowed to pass through.

The bit data within the Multiplexed BSD stream can originate from two independent BSD stream sources. One source is designated as Primary BSD Stream 564. The other is designated as Augmented Auxiliary BSD Stream 565. The BSD Mux block 510 selects from one of the two sources based upon the contents of Modulus block 530 and the number of BSD bits that have been inserted into the current frame of the output TDM stream. If the current inserted BSD bit count is less than the modulus value stored in the Modulus block 530, a Select output 567 causes the Primary BSD Stream to be selected. If the current BSD bit count is greater than or equal to the modulus value stored in the Modulus block 530, the Select output causes the Augmented Auxiliary BSD stream to be selected.

The current inserted BSD bit count is kept in the Modulus block 530. The comparison between the BSD bit count and the modulus value is made by the Modulus block which includes registers and a comparator combined with a single binary output, i.e., the Select output 567. The Modulus block counts inserted bits and switches the BSD Mux 510 at the appropriate point in time with the Select output with the condition that the BSD Insertion block 590 is demanding BSD bits as determined by the TDM Use map signal 581.

The value stored in the Modulus block 530 is determined by a Throttle module 520. The Throttle module 520 comprises electronic circuitry for adjusting the throughput rate based on the depth of Primary Bit Queue 500 received at the input of the throttle circuitry. The Throttle module 520 updates the value in the Modulus block using Update signal 543. The Control Timing block 540 coordinates the operation of the Throttle module such that the modulus value is changed at the start of an SFI time interval after an HCLP control message has been inserted into the auxiliary BSD stream. In an alternate embodiment, the functions of the Throttle module 520 and Primary Bit Queue 500 can be provided by one or more embedded processors.

The Primary BSD Stream Input 40 enters the DLBM transmit end and is accumulated within Primary Bit Queue 500. The Primary Bit Queue continuously increments a depth count 569 for every BSD bit that enters and continuously decrements the depth count for every bit supplied to the BSD Mux block 510. The depth information is passed to the Throttle block 520. Primary BSD Stream Input bits are discarded in the event that the Primary Bit Queue 500 has exhausted its storage capacity.

Bits with a value of zero (i.e., dummy bits) are supplied to the BSD Mux 510 in the case where the modulus value provided by the modulus 530 is greater than zero and the Primary Bit Queue 500 is empty.

At regular time intervals (e.g., on the order of 10 milliseconds) determined by the Control Timing block 540, a new modulus value is computed upon receipt of a Sample event signal 571. The value of the modulus can range from a minimum of zero to an established maximum. This maximum is equal to the total number of data bits that can occupy the frame time interval of the TDM data stream, minus eight to allow for a reserved control channel described herein. The modulus value is simply a partition of the total available BSD bandwidth between Primary BSD Stream bits and Auxiliary BSD Stream bits.

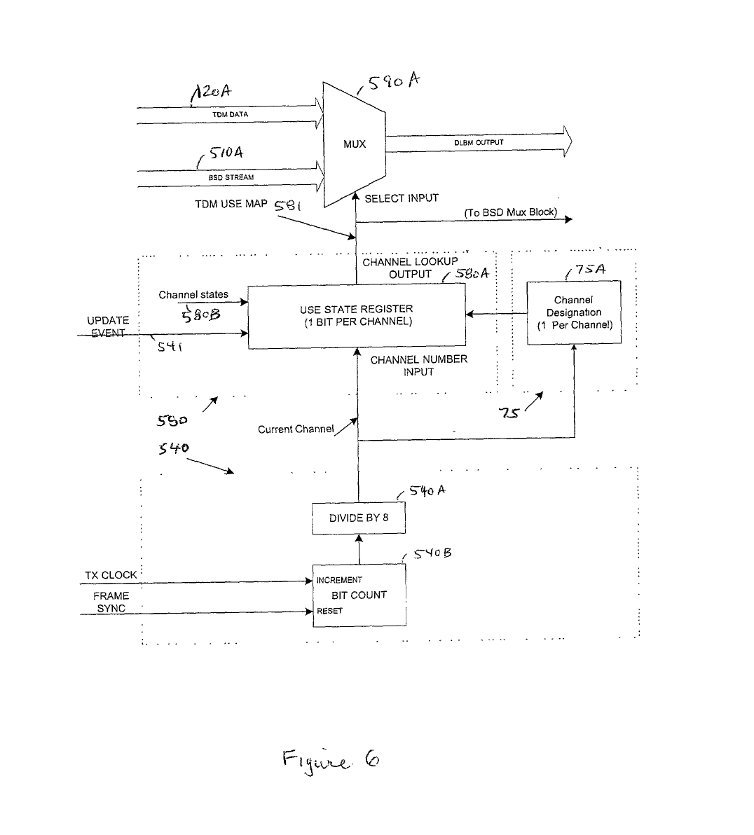

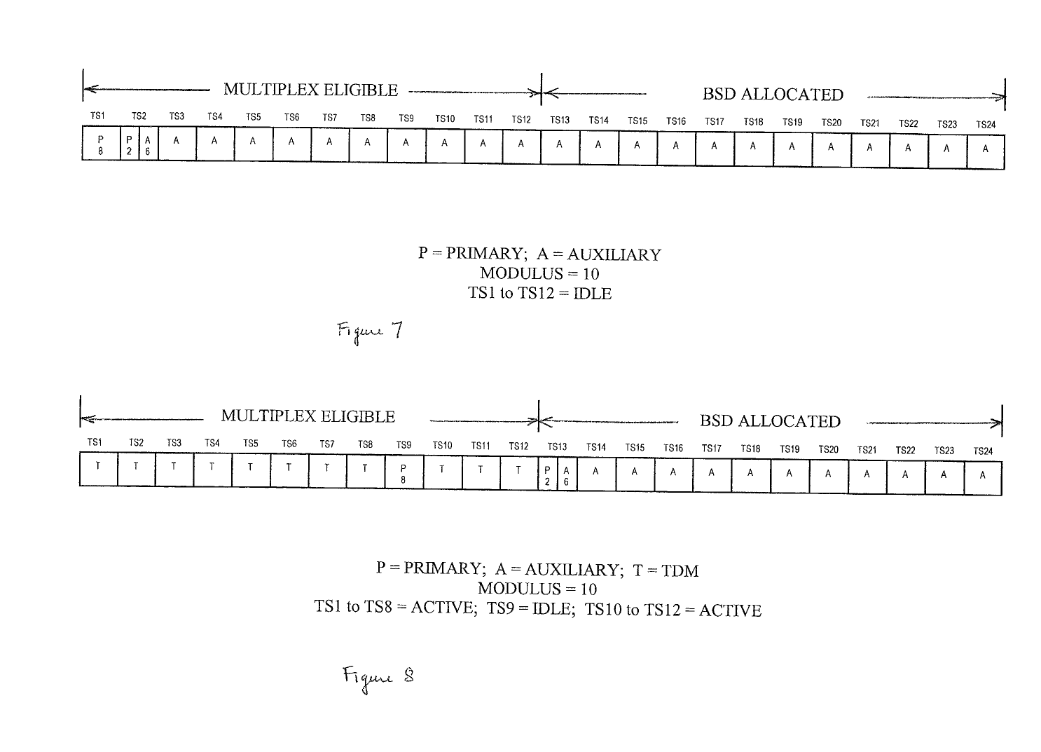

FIGS. 7 and 8 illustrate an example of the dynamic bandwidth allocation of the present approach for a modulus value of 10. In this example for a frame that has 24 time slots of 8 bits each, the first 12 time slots TS1 to TS12 are designated Multiplex Eligible and the remaining time slots TS13 to TS24 are designated BSD Allocated.

FIG. 7 illustrates the allocation or partition between primary (P) and auxiliary (A) data bits when the usage map indicates that all of the time slots designated Multiplex Eligible (i.e., TS1 to TS12) are IDLE. In particular, the first 10 bits of the 192 bits in the 24 time slots occupy time slots (8 bits in TS1; 2 bits in TS2) designated Multiplex Eligible to carry primary data. The remaining 182 bits carry auxiliary data.

FIG. 8 illustrates the allocation when the usage map indicates that TS9 is IDLE and TS1 to TS8, TS10 to TS12 are ACTIVE. In particular, 8 bits of primary data is carried in TS9 and 2 bits are carried in the first BSD Allocated time slot, i.e., TS13. The remaining 94 bits of the BSD Allocated time slots carry auxiliary data.

The Throttle module 520 performs a computation once per Sample event based upon the trend of the depth information (i.e., increasing, decreasing, or steady state), the value of the depth information, and the projected time to empty the Primary Bit Queue 500. If the value of the new modulus matches the value of the existing modulus, no further action is taken until the next Sample time interval. If the values are different, the demand for primary bandwidth has changed. Whenever a change is made in the modulus value at the TE, the RE must be updated with the new modulus value. To effect this update, the Throttle 520 triggers Hardware Control Link Protocol (HCLP) Insertion block 550 on insert signal line 573 to insert into the Auxiliary BSD stream a control command that contains the updated information. The control commands are described further herein.

The Auxiliary BSD Stream Input 60 enters the DLBM transmit end and is accumulated within Auxiliary Bit Queue 560. Auxiliary BSD Stream Input bits are discarded in the event that the Auxiliary Bit Queue 560 has exhausted its storage capacity. The accumulated BSD bits are supplied to the BSD Mux 510 through the HCLP Insertion block 550 at the appropriate time interval as determined by the current value of the Modulus and TDM use map. Bits with a value of zero are supplied to the HCLP Insertion block 550 in the case where the Auxiliary Bit Queue 560 is empty and the Modulus block 530 selects data from the Augmented Auxiliary BSD stream 565.

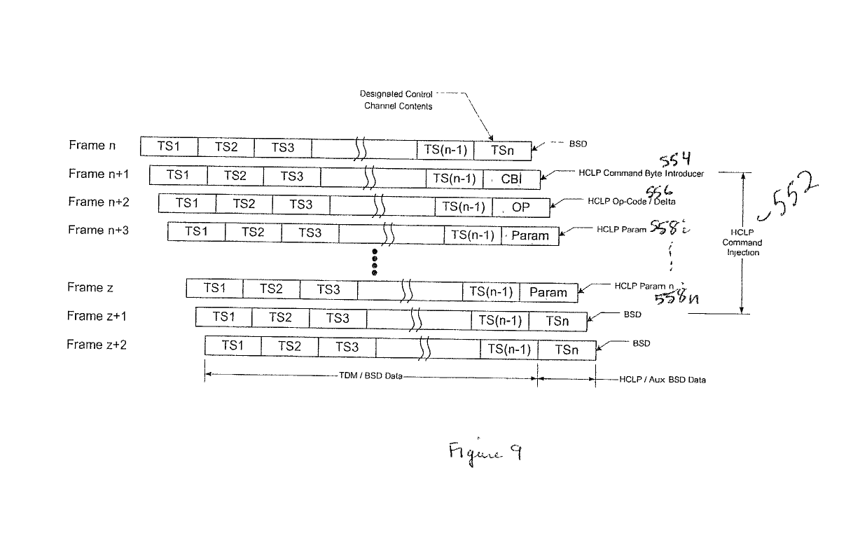

The Hardware Control Link Protocol (HCLP) Insertion block 550 is responsible for inserting commands into the Auxiliary BSD Stream in such a manner that the DLBM receive end can extract the command regardless of the current DLBM configuration. To do so, a TDM time slot is reserved for the exclusive transport of Auxiliary BSD bits with HCLP commands inserted as required. This time slot needs to be designated as BSD Allocated. FIG. 9 shows a preferred embodiment of the HCLP command 552 transmitted in the last TDM time slot of a frame. As shown, the HCLP command is interleaved with BSD data in the designated TDM time slot. HCLP commands are injected into the auxiliary BSD stream only when the corresponding TDM time slot is ready to transmit. The format of an HCLP command 552 comprises three elements: a Command Byte Introducer (CBI) 554, an 8 bit Op-Code 556 and any number of 8 bit parameters 558i. . . 558n.

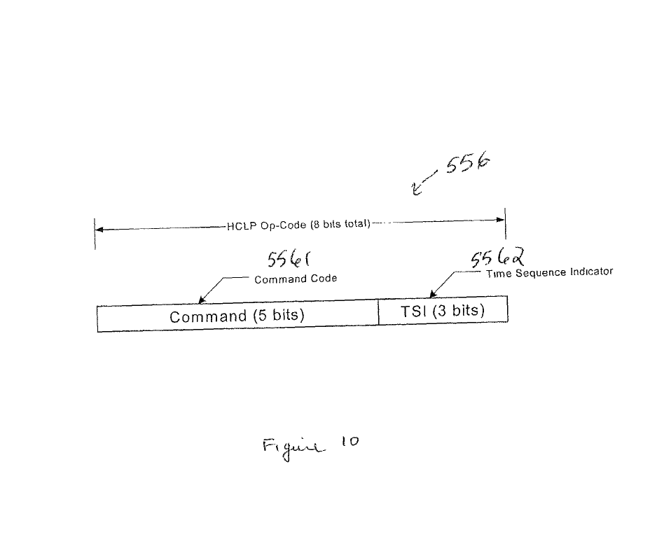

As shown in FIG. 10, the HCLP Op-Code 556 consists of two fields. The first 5 bits of the Op-Code identify a command Code 5561. The following 3 bits identify a Time Sequence Indicator (TSI) 5562. The TSI is used to reduce the probability of erroneous data corrupting the receive end.

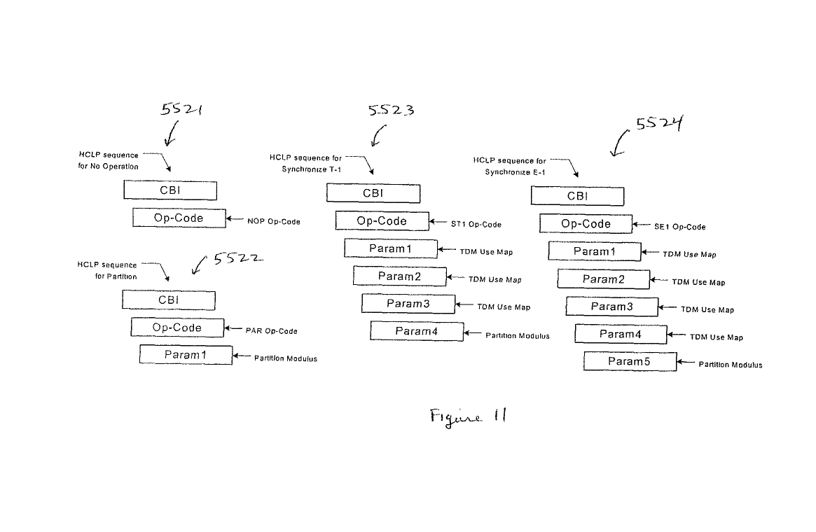

FIG. 11 shows four HCLP commands 5521, 5522, 5523, 5524 with various associated parameters. HCLP protocol rules allow the HCLP data to be distinguished from the auxiliary BSD stream and to be received reliably in error prone transmission media. Two types of HCLP commands are used to control the configuration of the DLBM receive end. The first type of command, called synchronize commands, are issued at periodic time intervals. In particular, synchronize commands 5523, 5524 can be used in T-1 and E-1 systems respectively. The E-1 Synchronize command 5524 is also appropriate for DSL systems of bandwidths up to 2.048 kbps. Other embodiments may add differing op-codes with more or less parameters to accommodate the appropriate bandwidth. Each command is used to transmit the current TDM use map and modulus information.

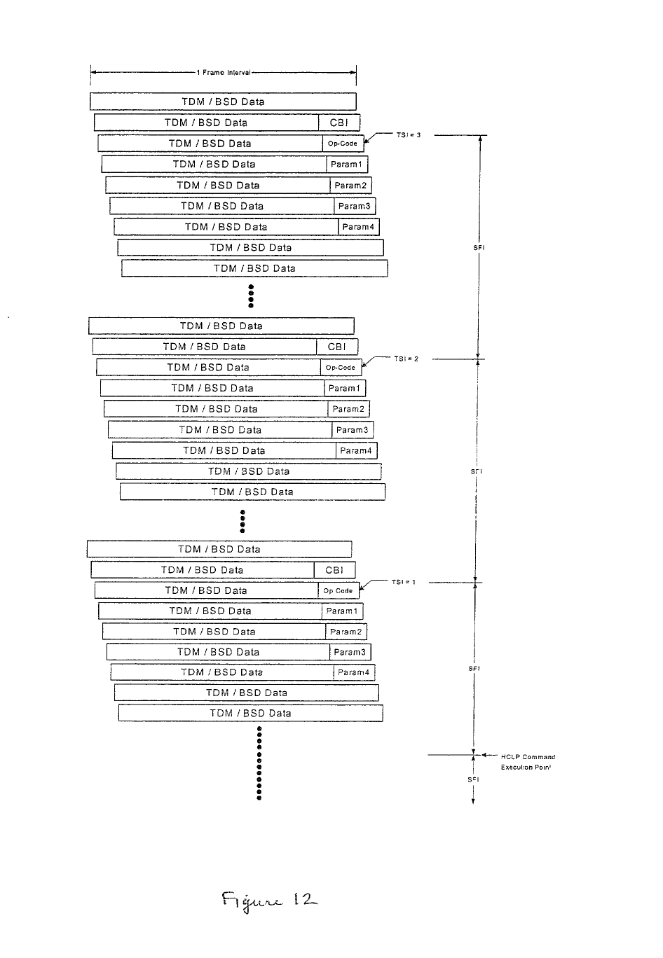

The Control Timing block 540 (FIG. 5) is responsible for coordinating the transmission of the HCLP command such that reception of the Op-Code corresponds to the start of an SFI time interval as shown in FIG. 12. In this manner, the DLBM receive end SFI time intervals are synchronized to the SFI time intervals established by the DLBM transmit end. This synchronization is needed to recover the signaling information embedded in the active TDM data channels. The second type of command, called the partition command 5522 (FIG. 11) is used to convey only the modulus information. The frequency of this command may be higher than the synchronize command 5523, 5524 and is not periodic. Since the synchronize command 5523, 5524 contains the modulus information, a scheduled synchronize command 5523, 5524 may be issued in place of a partition command 5522.

In the case where a HCLP command is to be inserted, the Auxiliary BSD stream data is held in its queue 560 (FIG. 5). Most of the time the Auxiliary BSD data is selected for transmission in the HCLP designated channel. Other times, the Auxiliary BSD data is held while an HCLP command byte is inserted in the HCLP designated channel. The Auxiliary BSD data is then transmitted at the first available bit configured for Auxiliary BSD data. This bit position will depend upon the value held in the modulus and the current state of the use map.

To allow the HCLP command to be interleaved with BSD data, special cases where the BSD data matches the CBI code must be handled. Such a case is termed a “coincident CBI event” (CCE). A CCE causes the HCLP insert block 550 (FIG. 5) in the TE to insert a no-operation (NOP) command into the designated HCLP TDM time slot on the next frame. FIG. 13 shows the CCE and resulting NOP command. The BSD data that triggered the insertion is held until the next available point in time allocated for Auxiliary BSD. This occurs at some point in the frame following the CBI and before the NOP if more than one TDM time slot is allocated to Auxiliary BSD traffic. HCLP protocol rules do not allow two HCLP commands to be transmitted in a row. This protocol rule allows the BSD data matching the CBI code to pass through in cases where only the designated HCLP time slot is available for Auxiliary BSD transport.

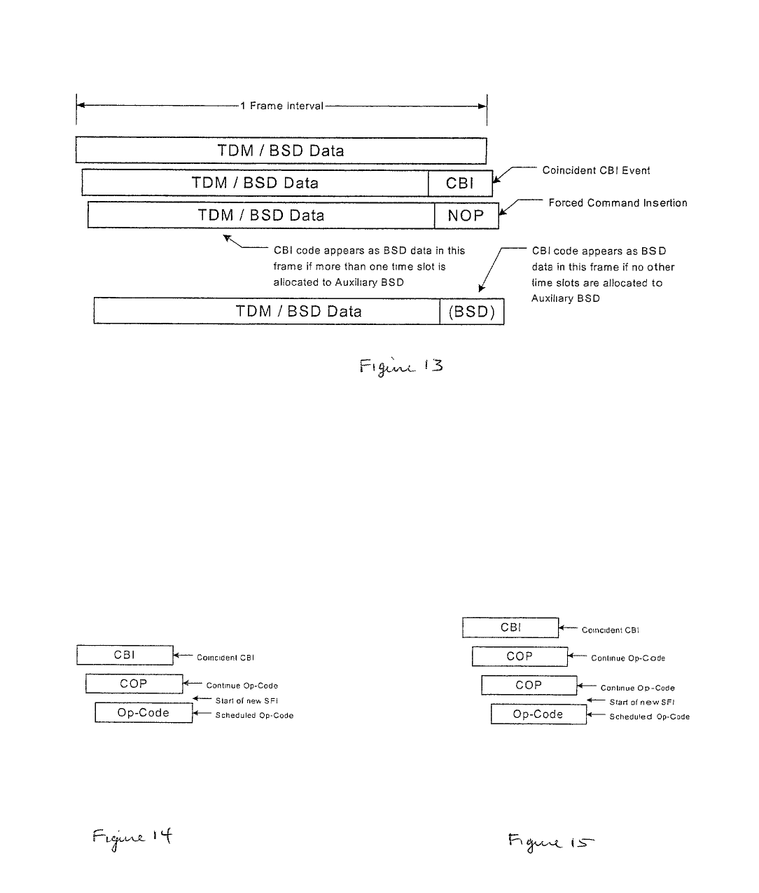

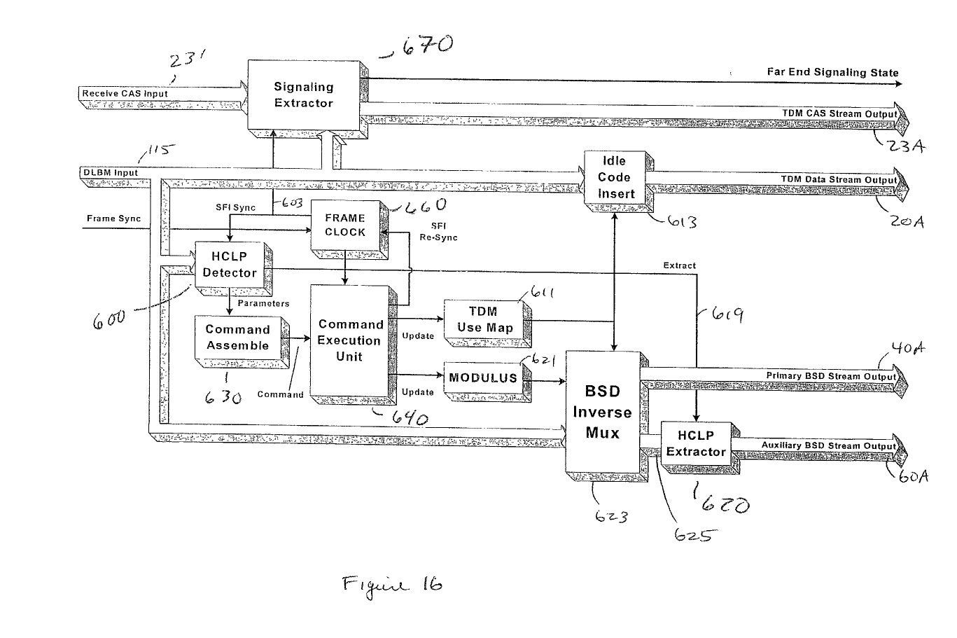

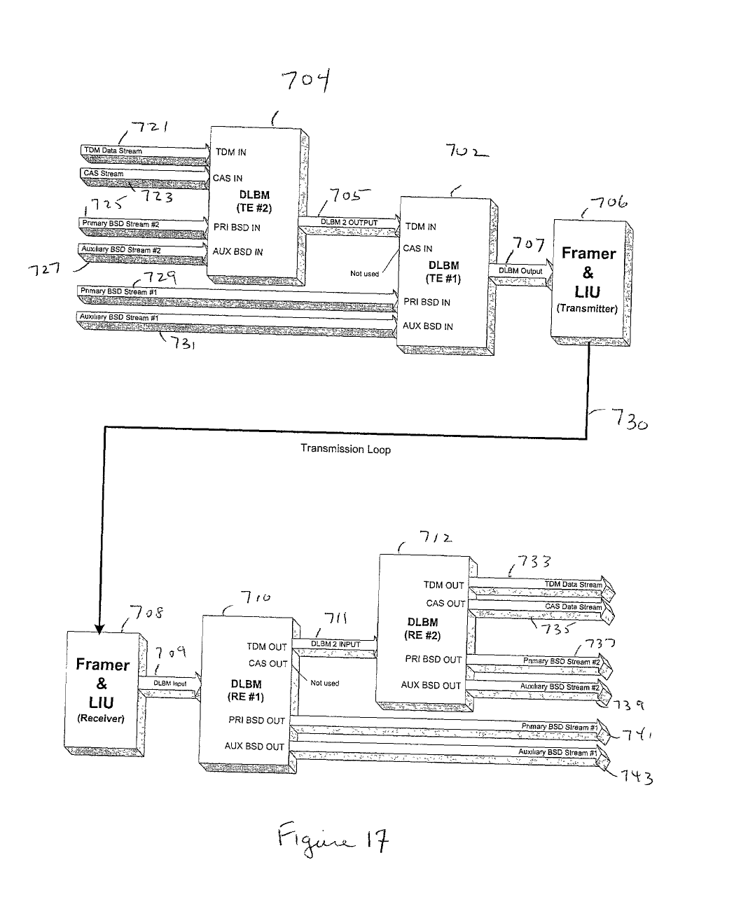

Two additional special cases are handled to allow the HCLP Op-Code to indicate the correct synchronization of the SFI. As shown in FIG. 12, the point in time at which the HCLP Op-Code is transmitted is always aligned with an SFI boundary. It is possible that a CCE would trigger the HCLP insert block 550 (FIG. 5) to alter such timing. To prevent such cases from happening, a special HCLP code is inserted prior to the Op-Code. This code is termed a “Continue Op-Code” (COP). Insertion of the COP code after the CBI instructs the HCLP detector 600 (described further herein with reference to FIG. 16) in the RE to wait until the next frame to recover a possible Op-Code. FIGS. 14 and 15 illustrate two possible cases where the COP code may be required to maintain SFI and Op-Code synchronization. Case 1 (FIG. 14) results when the BSD causes a CCE two frames prior to the SFI. In this case, a NOP cannot be allowed since the Op-Code would then be interpreted as BSD. Case 2 (FIG. 15) results when the BSD causes a CCE three frames prior to the SFI. In this case, a NOP could be inserted but the CBI needed to introduce the second command would be interpreted as BSD since HCLP protocol rules do not allow two HCLP commands to be transmitted in a row. If a CCE occurs four frames before an SFI and scheduled HCLP command, there is enough time to insert the NOP command and the scheduled command without sending two commands in a row. If a CCE occurs one frame before an SFI and scheduled command, the NOP is not needed and the command is sent as scheduled.

A block diagram of the DLBM receive end is shown in FIG. 16. A Receive CAS Input stream 23′ may optionally be present in the case where legacy TDM RBS is used on a portion of the TDM channels. In such cases, the associated CAS information is passed through to the TDM CAS Stream Output 23A unaltered. The DLBM Input 115 may contain data originating from any combination of available data sources input to the DLBM transmit end. Such data may consist of TDM data with or without embedded signaling information. It may also contain any combination of primary BSD and auxiliary BSD bit information originating from the DLBM TE multiplexed BSD stream 510 A (FIG. 5).

The DLBM Input data 115 is presented to HCLP Detector 600 which examines the DLBM Input data in the designated control link channel for HCLP commands. When an HCLP command is encountered, the corresponding HCLP command data bits are removed from the Auxiliary BSD Stream Output 60 A by HCLP Extractor 620 during the time interval that corresponds to the designated HCLP TDM channel. The HCLP Detector passes the appropriate command and parameter data to Command Assemble block 630. When the entire command has been received, it is passed to HCLP Command Execution Unit 640. The HCLP Command Execution Unit checks the TSI of each command and applies the appropriate voting rule to determine the correct command and point in time to execute the command.

An SFI Sync time interval 603 issued by Frame Clock 660 at the DLBM receive end is used by Signaling Extractor 670 to recover signaling information that is embedded in TDM channels. TDM channels designated as Multiplex Eligible and active by the current channel map are examined for a signaling bit. Signaling bits are recovered every sixth frame after the SFI time interval. When the TDM channel designated as Multiplex Eligible is identified as being idle by the current use map, the current state of the TDM CAS Stream Output 23A is retained and continuously output by Signaling Extractor block 670.

In an embodiment of the HCLP command transmission, the HCLP command execution unit 640 receives multiple occurrences of the same command but with decrementing TSI's. The sequence of received TSI's are used by the HCLP command execution unit in the RE to identify the correct point in time to implement the command. Each sequence number indicates the remaining number of times the command is to be repeated. The configuring device 80 (FIG. 2) manipulates the appropriate configuration registers 75 (FIG. 5) to establish the rule for the number of times a command is to be repeated. In cases where the rule allows only one transmission of a command, the command is assumed to have been transmitted correctly and is implemented immediately after the following frame interval. A case where two commands are transmitted in sequence is allowed but is not useful. The two-command case allows errors to be detected but there is no possibility of determining the correct command in the event of an error. In cases where three or more commands are required, the command with the most number of matches and correct time sequence is implemented at the appropriate point in time. When the command is executed, the frame clock is adjusted to establish an SFI time interval synchronous to the DLBM transmit end.

An Idle Code Insert block 613 operates on TDM channels designated as Multiplex Eligible that are received at the DLBM Input 115. When the TDM channel designated as Multiplex Eligible is identified as being idle by the current use map, the Idle Code Insert block 613 inserts a data byte into the output stream. The data byte is defined by the configuring device and stored in the DLBM configuration registers 75 (FIG. 5). The data byte is continuously output until the TDM use map identifies the TDM channel as being active at which time the DLBM Input data 115 is allowed to pass through unaltered.

A BSD Inverse Multiplexer (Mux) block 623 operates on TDM channels designated as Multiplex Eligible and BSD Allocated that are received at the DLBM Input 115. The BSD Inverse Mux receives the current TDM use map 611 and modulus value 621 that are updated by HCLP commands originating from the DLBM transmit end. TDM channels designated as Multiplex Eligible and identified as idle by the TDM use map are concatenated with TDM channels designated as BSD allocated. The concatenated BSD stream contains a ratio of Primary BSD and Auxiliary BSD bits in any given frame. The ratio of Primary BSD to Auxiliary BSD is determined by the modulus value in the DLBM transmit end. The same modulus value is sent to the DLBM receive end via HCLP commands such that the receive end modulus value always matches the transmit end modulus value for any given frame. The modulus value is then used to separate the BSD stream into Primary BSD Stream Output 40A and Augmented Auxiliary BSD Stream Output 625. The Augmented Auxiliary BSD Stream Output 625 contains the HCLP commands inserted into the original Auxiliary BSD Stream Input 60 (FIG. 5). The HCLP Extractor 620 removes all HCLP data when instructed by an Extract signal 619 originating from the HCLP Detector block. The resultant Auxiliary BSD Stream Output 60 A then matches the original input to the DLBM transmit end.

Applications can arise wherein more than two BSD channels with dynamic bandwidth requirements are needed. One approach by which such an application can be accommodated is shown in FIG. 17 which shows a block diagram wherein multiple DLBMs are cascaded to provide multiple primary and auxiliary BSD channels allowing for a variety of service classes and data networks. The cascaded configuration includes first and second TEs 702, 704 and first and second REs 710, 712. For simplicity, only one direction of transmission is shown.

At the transmit end, the second TE 704 includes TDM input stream 721, CAS input stream 723, primary BSD input stream 725 and auxiliary BSD input stream 727. The output stream 705 of the second TE 704 provides a TDM input stream to the first TE 702. The first TE 702 also includes primary BSD input stream 729 and auxiliary BSD input stream 731. Output stream 707 is provided to framer 706 which connects a framed output signal to transmission loop 730.

On the receive end, framer 708 connects DLBM input stream 709 to the first RE 710. Output stream 711 of the first RE 710 provides the input stream to the second RE 712. In addition, first RE 710 provides primary BSD output stream 741 and auxiliary BSD output stream 743. The second RE 712 provides TDM output stream 733, CAS output stream 735, primary BSD output stream 737 and auxiliary BSD output stream 739.

To properly cascade the second TE 704, the first TE 702 is configured to designate a portion of the TDM input as TDM Allocated. The second TE designates the same portion of bandwidth for its use and designates all other time slots as not used. Each TE RE pair (702, 710 and 704, 712) designates a DS0 to insert and recover an HCLP channel.

The net effect of the cascaded operation is the addition of primary and auxiliary BSD streams 729, 731. In this configuration, the two streams 729, 731 would not have the benefit of multiplexing idle TDM time slots but would have the ability to trade bandwidth based on the demand of the primary BSD stream. This limitation can be overcome by modifying the embodiment of the base TE/RE pair to accommodate plural primary and auxiliary BSD stream inputs within a single TE/RE pair by the duplication of corresponding bit queues (FIGS. 5 and 16) and expansion of the HCLP command set.

While this invention has been particularly shown and described with references to preferred embodiments thereof, it will be understood by those skilled in the art that various changes in form and details may be made therein without departing from the scope of the invention encompassed by the appended claims. For example, the above-described system and method can be implemented as a combination of hardware and software functionality. However, a preferred implementation of the function blocks disclosed herein can be in the form of a pure logic device. Several types of logic devices that can be used to implement the present invention include a custom application specific integrated circuit (ASIC) or field programmable gate array (FPGA). In such cases, software may be required. Further, when the above invention is implemented as an integrated circuit (IC), the IC resides at both ends of the transmission loop and is integrated with other standard ICs that implement the actual transmission line system. CLAIMS

What is claimed is:

1. Apparatus comprising:
first and second bit streams; and
an insertion circuit for combining the first and second bit streams into a time division multiplexed (TDM) output bit stream, the first bit stream being a TDM input bit stream, the TDM input and output bit streams being divisible into frames, each frame including plural channels, the second bit stream being an unframed stream of bit sequential data (BSD), wherein the insertion circuit is adapted to insert bits from the second bit stream into at least one channel of the first bit stream; and
a control interleaver for interleaving control information with the BSD wherein the control information includes bandwidth allocation information between the TDM input and the BSD.

2. The apparatus of claim 1 wherein the control interleaver is adapted to interleave the control information into at least one channel of the TDM input bit stream that is designated for carrying BSD only.

3. The apparatus of claim 1 wherein the insertion circuit is adapted to insert bits from the second bit stream into at least one channel of the TDM input bit stream that is designated for carrying either TDM data or BSD depending on a usage state of the channel.

4. The apparatus of claim 3 further comprising an idle channel detector for detecting the usage state of channels of the TDM input bit stream from examination of a channel associated signaling stream corresponding to the TDM input bit stream.

5. The apparatus of claim 4 wherein for a detected usage state of IDLE for a TDM input stream channel, the insertion circuit inserts bits from the second bit stream, and wherein for a detected usage state of ACTIVE for a TDM input stream channel, the insertion circuit inserts no bits from the second bit stream.

6. The apparatus of claim 1 further comprising a multiplexer for multiplexing at least one primary BSD bit stream and at least one auxiliary BSD bit stream to provide the second bit stream.

7. The apparatus of claim 6 wherein the primary BSD bit stream comprises real time packet data and the auxiliary BSD bit stream comprises non-real time packet data.

8. The apparatus of claim 6 wherein the multiplexer is adapted to select between the primary BSD bit stream and the auxiliary BSD bit stream based on a modulus value indicating an allocation of available BSD bandwidth between the primary and auxiliary BSD bit streams.

9. The apparatus of claim 8 further comprising a throttle circuit for adjusting the modulus value based on an input rate associated with the primary BSD bit stream.

10. The apparatus of claim 9 further comprising a primary bit queue for holding bits of the primary BSD bit stream wherein the throttle circuit monitors depth of the primary bit queue and adjusts the modulus value based upon rate of change in the depth and a projected time to empty the primary bit queue.

11. The apparatus of claim 6 wherein the auxiliary BSD bit stream includes control information interleaved with BSD.

12. The apparatus of claim 11 further comprising a hardware control link protocol (HCLP) insertion circuit for inserting the control information in HCLP commands.

13. The apparatus of claim 12 wherein the insertion circuit inserts the HCLP commands into a channel of the TDM input bit stream designated for carrying BSD and control information.

14. The apparatus of claim 11 wherein the control information includes a modulus value indicating an allocation of available BSD bandwidth between the primary and auxiliary BSD bit streams.

15. The apparatus of claim 11 wherein the control information includes usage state information corresponding to channels of the TDM input bit stream.

16. The apparatus of claim 11 wherein the control information is repeated at least once to permit error detection at a far end device.

17. The apparatus of claim 11 wherein the control information is repeated at least twice to permit error correction at a far end device.

18. The apparatus of claim 1 further comprising a signaling insertion circuit for inserting signaling information from a channel associated signaling stream into corresponding channels of the TDM input bit stream.

19. The apparatus of claim 18 further comprising a control timing circuit for establishing a signal frame interval (SFI) comprising twenty-four frame intervals of the TDM input bit stream.

20. The apparatus of claim 19 further comprising a hardware control link protocol (HCLP) insertion circuit for inserting an HCLP command into a designated control channel, the HCLP command indicating start of the SFI.

21. The apparatus of claim 20 wherein the signaling information includes ABCD signaling bits, the signaling insertion circuit adapted to insert the A bit into the corresponding channel in the sixth frame of the SFI, the B bit into the corresponding channel of the twelfth frame of the SFI, the C bit into the corresponding channel of the eighteenth frame of the SFI, and the D bit into the corresponding channel of the twenty-fourth frame of the SFI frame.

22. The apparatus of claim 1 further comprising a transmission loop and a line interface unit for coupling the TDM output bit stream to the transmission loop.

23. The apparatus of claim 22 wherein the transmission loop is a T1 carrier.

24. The apparatus of claim 22 wherein the transmission loop is an E1 carrier.

25. The apparatus of claim 22 wherein the transmission loop is a digital subscriber line.

26. A method of communication comprising:
providing first and second bit streams; and
combining the first and second bit streams into a time division multiplexed (TDM) output bit stream, the first bit stream being a TDM input bit stream, the TDM input and output bit streams being divisible into frames, each frame including plural channels, the second bit stream being an unframed stream of bit sequential data (BSD), wherein combining includes inserting bits from the second bit stream into at least one channel of the first bit stream and interleaving control information with the BSD wherein the control information includes bandwidth allocation information between the TDM input and the BSD.

27. The method of claim 26 wherein interleaving includes interleaving the control information into at least one channel of the TDM input bit stream that is designated for carrying BSD only.

28. The method of claim 26 wherein inserting includes inserting bits from the second bit stream into at least one channel of the TDM input bit stream that is designated for carrying either TDM data or BSD depending on a usage state of the channel.

29. The method of claim 28 further comprising detecting the usage state of channels of the TDM input bit stream by examining a channel associated signaling stream corresponding to the TDM input bit stream.

30. The method of claim 26 further comprising multiplexing at least one primary BSD bit stream and at least one auxiliary BSD bit stream to provide the second bit stream.

31. The method of claim 30 wherein the primary BSD bit stream comprises real time packet data and the auxiliary BSD bit stream comprises non-real time packet data.

32. The method of claim 30 wherein multiplexing includes selecting between the primary BSD bit stream and the auxiliary BSD bit stream based on a modulus value indicating an allocation of available BSD bandwidth between the primary and auxiliary BSD bit streams.

33. The method of claim 32 further comprising adjusting the modulus value based on an input rate associated with the primary BSD bit stream.

34. The method of claim 33 further comprising holding bits of the primary BSD bit stream in a primary bit queue and wherein adjusting includes adjusting the modulus value based upon rate of change in the depth of the primary bit queue and a projected time to empty the primary bit queue.

35. The method of claim 30 further including interleaving control information with auxiliary BSD in a control channel.

36. The method of claim 35 wherein the control information includes a modulus value indicating an allocation of available BSD bandwidth between the primary and auxiliary BSD bit streams.

37. The method of claim 35 wherein the control information includes usage state information corresponding to channels of the TDM input bit stream.

38. The method of claim 35 wherein interleaving includes repeating the control information at least once to permit error detection at a far end device.

39. The method of claim 35 wherein interleaving includes repeating the control information at least twice to permit error correction at a far end device.

40. The method of claim 26 further comprising inserting signaling information from a channel associated signaling stream into corresponding channels of the TDM input bit stream.

41. The method of claim 40 further comprising establishing a signal frame interval (SFI) comprising twenty-four frame intervals of the TDM input bit stream and wherein inserting signaling information includes inserting ABCD signaling bits, with the A bit inserted into the corresponding channel in the sixth frame of the SFI, the B bit inserted into the corresponding channel of the twelfth frame of the SFI, the C bit inserted into the corresponding channel of the eighteenth frame of the SFI, and the D bit inserted into the corresponding channel of the twenty-fourth frame of the SFI frame.

42. The method of claim 26 further comprising cascading the TDM output stream with a second BSD bit stream to provide a second TDM output stream.

43. The method of claim 42 further comprising multiplexing a primary BSD bit stream and an auxiliary BSD bit stream to provide the second BSD bit stream.

44. Apparatus comprising:
a time division multiplexed (TDM) input stream divisible into frames, each frame having plural channels including channels designated for carrying either TDM data or bit sequential data (BSD) depending on usage state information of the channels; and
an inverse multiplexer for separating data in the BSD channels into a primary BSD output bit stream and an auxiliary BSD output bit stream based on the usage state information and a modulus value indicating an allocation of available BSD bandwidth between the primary and auxiliary BSD streams.

45. The apparatus of claim 44 further comprising a control channel detector for examining a control channel in the TDM input stream to determine the usage state information and modulus value.

46. The apparatus of claim 44 further comprising an idle code insertion circuit for inserting idle code into TDM channels designated IDLE in the usage state information to provide a TDM output stream.

47. The apparatus of claim 44 wherein the primary BSD bit stream comprises real time packet data and the auxiliary BSD bit stream comprises non-real time packet data.

48. A method of communication comprising:
receiving a time division multiplexed (TDM) input stream divisible into frames, each frame having plural channels including channels designated for carrying either TDM data or bit sequential data (BSD) depending on usage state information of the channels; and
separating data in the BSD channels into a primary BSD output bit stream and an auxiliary BSD output bit stream based on the usage state information and a modulus value indicating an allocation of available BSD bandwidth between the primary and auxiliary BSD streams.

49. The method of claim 48 further comprising examining a control channel in the TDM input stream to determine the usage state information and modulus value.

50. The method of claim 48 further comprising inserting idle code into TDM channels designated IDLE in the usage state information to provide a TDM output stream.

51. The method of claim 48 wherein the primary BSD bit stream comprises real time packet data and the auxiliary BSD bit stream comprises non-real time packet data.

52. A method of dynamically controlling bandwidth associated with real time and non-real time data on a transmission loop, the method comprising:
providing a first channel carrying real time data;
providing a second channel carrying non-real time data; and
controlling the throughput of the first or second channel by matching the real time data input to the loop transmission rate via a control channel.

53. The method of claim 52 further comprising providing a third channel carrying TDM data and wherein controlling includes recovering idle bandwidth of the third channel to provide at least a portion of the first and second channels.

54. A method of communication comprising:
multiplexing primary and auxiliary bit sequential data (BSD) streams to provide an unframed BSD bit stream;
combining the unframed BSD bit stream with a time division multiplexed (TDM) input bit stream to provide a TDM output bit stream, the TDM output bit stream divisible into frames, each frame having plural channels including channels designated for carrying either TDM data or BSD depending on usage state information of the channels;
interleaving control information with the BSD wherein the control information includes the usage state information and a modulus value indicating an allocation of available BSD bandwidth between the primary and auxiliary BSD streams;
transmitting the TDM output bit stream to a receive end;
receiving the TDM output stream at the receive end; and
separating data in the BSD channels into a primary BSD output bit stream and an auxiliary BSD output bit stream based on the usage state information and the modulus value indicating the allocation of available BSD bandwidth between the primary and auxiliary BSD streams.
